(19) United States
(12) Patent Application Publication
(10) Pub. No.: US 2026/0367216 A1
(43) Pub. Date: Nov. 19, 2026

(54) DISTANCE SENSING SYSTEM AND METHOD THEREOF

(71) Applicant: Delta Electronics, Inc., Taoyuan City (TW)

(72) Inventors: Chia-Ju Peng, Taoyuan City (TW); Chow Yong Ng, Taoyuan City (TW); Wei-Cheng Tian, Taoyuan City (TW)

(21) Appl. No.: 19/269,480

(22) Filed: Jul. 15, 2025

(30) Foreign Application Priority Data
May 15, 2025 (CN) 202510622978.X

(51) Int. Cl. G01S 7/02; G01S 13/08

(52) U.S. Cl. CPC G01S 7/023; G01S 13/08

(57) ABSTRACT

A distance sensing system and a method thereof are disclosed. The distance sensing system includes a transmitter, a receiver and a controller. The transmitter outputs a reference transmission signal, and the receiver receives a reference reception signal corresponding to the reference transmission signal and served as an interference compensation signal. A transmission signal is outputted to a target object at a starting time by the transmitter outputs, and reflected to form a reflection signal. The receiver receives a reception signal including an interference signal received at a first time and a reflection signal received at a second time. The controller filters out the interference signal in the reception signal according to the interference compensation signal, to obtain the reflection signal in the reception signal. The controller calculates a distance between the sensing system and the target object based on the time difference between the starting time and the second time.

### CROSS-REFERENCE TO RELATED APPLICATION

This application claims priority to China Patent Application No. 202510622978.X, filed on May 15, 2025. The entireties of the above-mentioned patent application are incorporated herein by reference for all purposes.

### FIELD OF THE INVENTION

The present disclosure relates to a distance sensing system and a method thereof, and more particularly to a distance sensing system and a method thereof for improving the sensing accuracy and overcoming the blind zone limitation of close-range distance sensing.

### BACKGROUND OF THE INVENTION

Distance sensing systems (also referred to as rangefinders) are used to measure the distance between a sensor and a target object, thereby providing important distance information for applications such as ranging, positioning, navigation, and collision avoidance. There are two types of existing distance sensing technologies. One of the technologies utilizes one single sensor combined with a switch to transmit and receive signals. Specifically, the sensor outputs a transmission signal to the target object in a transmitting mode, and then the switch switches the sensor to a receiving mode, so that the signal is reflected from the target object and received by the same sensor. In this way, the distance sensing system can analyze the distance between the sensor and the target object according to the reflection signal. However, in this technology, since the same sensor needs to output and receive signals at different timings, in order to prevent the signal received by the sensor from being interfered by the transmission signal, it is necessary to wait until the transmission signal is completely transmitted before receiving the correct reception signal without the interference of the transmission signal. Otherwise, the distance between the sensor and the target object cannot be correctly sensing. In this manner, a blind zone of the distance sensing system is formed at the period before the sensor starts to receive the reception signal.

In the other technique, the system has a transmitter and a receiver spaced apart to transmit and receive signals, respectively. Specifically, the transmitter outputs a transmission signal to a target object, and the receiver receives a reflection signal after being reflected by the target object. The system analyzes the distance between the system and the target object based on the transmission signal and the reflection signal. In this method, although the transmitter and the receiver are spaced apart at a certain distance to avoid mutual interference between the transmission signal and the reflection signal, the transmitter and the receiver can operate at the same time. Moreover, the receiver can continue to receive signals without waiting for the transmitter. Therefore, when the transmitter outputs the transmission signal, there is still noise that will be transmitted laterally to the receiver and directly received by the receiver, so that the reflection signal received by the receiver is interfered, and the so-called internal crosstalk is formed. Therefore, the distance sensing accuracy cannot be improved, it is difficult for the distance sensing system to achieve distance sensing of closer target objects, and this results in the blind zone limitation of close-range distance sensing for the distance sensing system.

In some applications, especially in the fields of automobiles, robotics, and smart manufacturing, the distance information obtained by the distance sensing system is a key safety issue for applications such as ranging, positioning, navigation, and collision avoidance. For example, the blind zone of a distance sensing system makes it difficult to sense the object at a relatively close distance, and it makes close-range collision avoidance applications potentially dangerous.

Therefore, there is a need of providing a distance sensing system and a method thereof to address the deficiencies of conventional technologies.

### SUMMARY OF THE INVENTION

An object of the present disclosure is to provide a distance sensing system and method. When a distance to a target is sensed, it allows to filter out interference components in the reception signal received by the receiver based on a pre-measured interference compensation signal. Furthermore, the distance between the system and the target object is calculated based on the reception signal without interference components, so that the distance sensing accuracy is improved and the blind zone limitation of close-range distance sensing is overcome.

In accordance with an aspect of the present disclosure, a distance sensing system is provided. The distance sensing system includes a transmitter, a receiver and a controller. The transmitter outputs a reference transmission signal in a first direction. The receiver receives a reference reception signal corresponding to the reference transmission signal. The controller is connected to the transmitter and the receiver and includes a storage unit, wherein the controller uses the reference reception signal as an interference compensation signal and stores the interference compensation signal in the storage unit. The transmitter is further used to output a transmission signal toward a target object in the first direction at a starting time, and the transmission signal forms a reflection signal after being reflected by the target object, wherein the receiver is further used to receive a reception signal, and the reception signal comprises an interference signal received at a first time and the reflection signal received at a second time. The controller is further used to filter out the interference signal in the reception signal according to the interference compensation signal to obtain the reflection signal in the reception signal. The controller is further used to calculate a distance between the transmitter and the target object according to a time difference between the starting time and the second time.

In accordance with an aspect of the present disclosure, a distance sensing method of a distance sensing system is provided. The distance sensing system includes a transmitter, a receiver and a controller, and the distance sensing method includes steps of: (S1) executing a signal preprocessing procedure for outputting a reference transmission signal in a first direction through the transmitter, receiving a reference reception signal corresponding to the reference transmission signal through the receiver, using the reference reception signal as an interference compensation signal through the controller, and storing the interference compensation signal in a storage unit of the controller; (S2) outputting a transmission signal through the transmitter in the first direction toward a target object at a starting time and receiving a reception signal through the receiver, wherein the transmission signal forms a reflection signal after being reflected by the target object, wherein the reception signal includes an interference signal received at a first time and the reflection signal received at a second time; (S3) processing the interference compensation signal, the transmission signal and the reception signal through the controller, and filtering out the interference signal in the reception signal according to the interference compensation signal to obtain the reflection signal in the reception signal; (S4) obtaining the starting time according to the processed transmission signal, and obtaining the first time and the second time according to the processed reception signal through the controller; and (S5) calculating a distance between the transmitter and the target object according to a time difference between the starting time and the second time through the controller.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A is a schematic block diagram illustrating a distance sensing system according to an embodiment of the present disclosure;

FIG. 1B is a schematic diagram illustrating an arrangement of the distance sensing system of FIG. 1A and a target object;

FIG. 1C is a schematic structural view illustrating the distance sensing system of FIG. 1A;

FIG. 2 is a signal diagram illustrating a reference transmission signal and a reference reception signal of the transmitter and the receiver in FIG. 1C;

FIG. 3A is a signal diagram illustrating a transmission signal and a reception signal of the transmitter and the receiver in FIG. 1B;

FIG. 3B is a schematic diagram illustrating that the compensation envelope signal and the interference envelope signal are matched;

FIG. 3C is a schematic diagram illustrating that the compensation envelope signal and the interference envelope signal are not matched, and a convex state is caused;

FIG. 3D is a schematic diagram illustrating that the compensation envelope signal and the interference envelope signal are not matched and a concave state is caused;

FIG. 4 is a flow chart illustrating a distance sensing method according to a first embodiment of the present disclosure;

FIG. 5 is a flow chart illustrating a distance sensing method according to a second embodiment of the present disclosure; and

FIG. 6A and FIG. 6B are a flow chart illustrating a distance sensing method according to a third embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

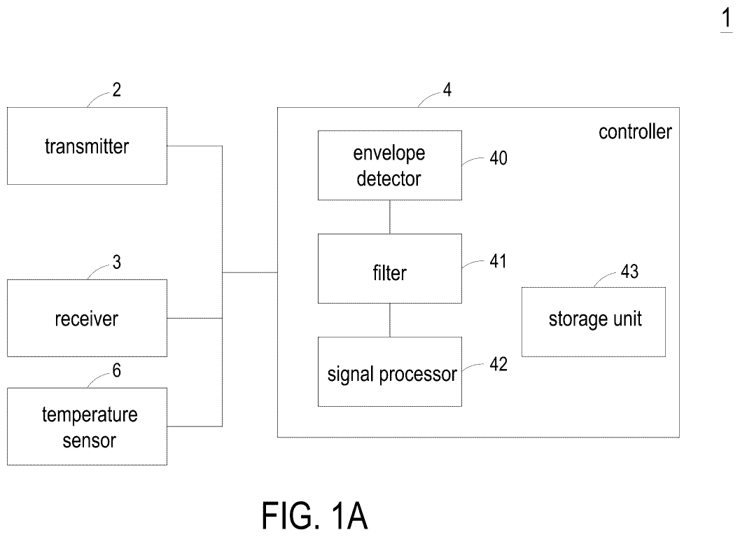

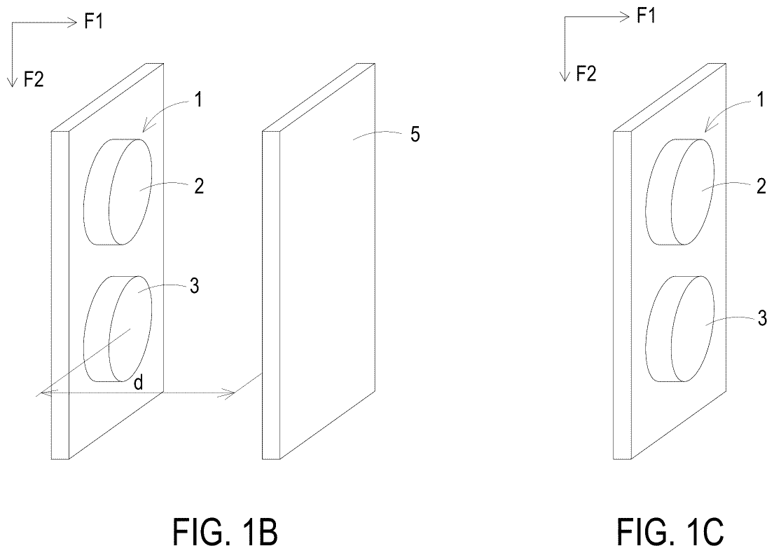

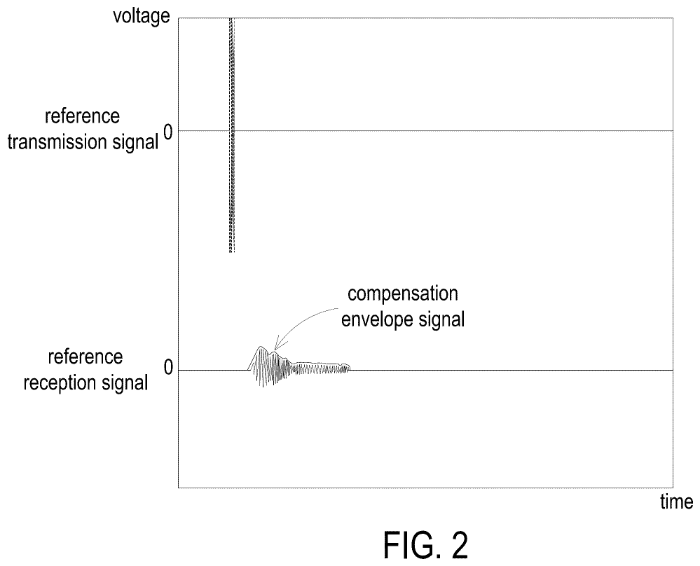

FIG. 1A is a schematic block diagram illustrating a distance sensing system 1 according to an embodiment of the present disclosure. FIG. 1B is a schematic diagram illustrating an arrangement of the distance sensing system 1 of FIG. 1A and a target object 5. Preferably but not exclusively, the distance sensing system 1 (or called rangefinders) of the present disclosure is an ultrasonic ranging system. In the embodiment, the distance sensing system 1 includes a transmitter 2, a receiver 3, and a controller 4. The controller 4 is connected to the transmitter 2 and the receiver 3. The transmitter 2 is used to output a transmission signal in a first direction F1 toward the target object 5 at a starting time T0. Preferably but not exclusively, the transmission signal is an ultrasonic signal. The receiver 3 and the transmitter 2 are arranged in a second direction F2, and the second direction F2 is perpendicular to the first direction F1. The receiver 3 is further used to receive a reception signal, and the reception signal includes an interference signal received at a first time T1 and the reflection signal received at a second time T2. Preferably but not exclusively, the interference signal is a signal received by the receiver 3 without being reflected by the target object 5, and the reflection signal is a signal received by the receiver 3 after the transmission signal is reflected by the target object 5. Since the interference signal is the signal received by the receiver 3 without being reflected by the target object 5, the interference signal can be regarded as interference generated by the transmitter 2 on the receiver 3. In some embodiments, the second direction F2 is not limited to being perpendicular to the first direction F1, and the direction relationship between the first direction F1 and the second direction F2 only needs to satisfy that the receiver 3 can receive the reflection signal reflected by the target object 5.

Since the reflection signal is generated after being reflected by the target object 5, it allows the controller 4 of the present disclosure to calculate a distance d between the distance sensing system 1 and the target object 5 by using a time difference between the transmission signal outputted and the reflection signal received. In other words, the controller 4 calculates the distance d between the distance sensing system 1 and the target object 5 according to the time difference between the starting time T0 and the second time T2.

In the embodiment, the distance d between the distance sensing system 1 and the target object 5 is calculated according to the following formula:

$$d = \frac{( T 2 - T 0 ) * V}{2} \qquad ( 1 )$$

Notably, d is the distance, T2 is the second time, TO is the starting time, and V is a transmission speed of the transmission signal. The transmission speed is related to the ambient temperature. In some embodiments, the distance sensing system 1 of the present disclosure further includes a temperature sensor 6 electrically connected to the controller 4 for sensing an ambient temperature. Whereby, it allows the controller 4 to adjust the transmission speed of the transmission signal according to the ambient temperature sensed by the temperature sensor 6. Therefore, the controller 4 can calculate the distance d between the distance sensing system 1 and the target object 5 according to the starting time T0, the second time T2 and the transmission speed of the transmission signal.

In the present disclosure, the distance between the distance sensing system 1 and the target object 5 needs to be calculated based on the starting time T0 and the second time T2. However, if the first time T1 and the second time T2 are close, the interference signal and the reflection signal will be close to each other or even overlap. In that, it is difficult to distinguish the reflection signal contained in the reception signal. Consequently, the accuracy of the distance calculation is affected and limited by the blind zone of system's ranging. Therefore, in the present disclosure, the reception signal is processed to obtain the reflection signal in the reception signal, thereby preventing the distance calculation from being affected by the interference signal.

Specifically, in the distance sensing system 1 of the present disclosure, a signal preprocessing procedure is first performed. The transmitter 2 and the receiver 3 are respectively used to transmit and receive signals in advance without the target object 5, so as to obtain an interference compensation signal. Then, the transmitter 2 and the receiver 3 are used to transmit and receive signals in the presence of the target object 5, and the reception signal in the presence of the target object 5 is processed through the interference compensation signal to obtain the reflection signal in the reception signal, thereby calculating the distance between the distance sensing system 1 and the target object 5.

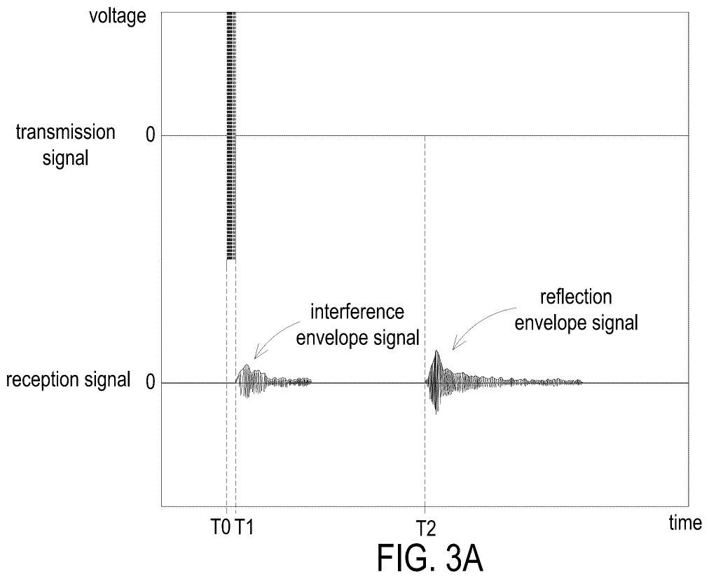

In the absence of the target object, how the transmitter and the receiver of the present disclosure transmit and receive signals to obtain an interference compensation signal is described as the following. FIG. 1C is a schematic structural view illustrating the distance sensing system 1 of FIG. 1A. FIG. 2 is a signal diagram illustrating a reference transmission signal and a reference reception signal of the transmitter 2 and the receiver 3 in FIG. 1C. Please refer to FIG. 1A, FIG. 1C and FIG. 2 simultaneously. In the embodiment, the controller 4 drives the transmitter 2 to operate, so that the transmitter 2 outputs a reference transmission signal in a first direction F1. Preferably but not exclusively, the reference transmission signal is an ultrasonic signal. In the embodiment, the controller 4 also drives the receiver 3 to operate, so that the receiver 3 receives a reference reception signal corresponding to the reference transmission signal. Since there is no target object in the first direction F1 in FIG. 1C, there is no reflection signal in this disclosure. The reference reception signal received by the receiver 3 is a signal directly received by the receiver 3 without being reflected by any target object. Therefore, the reference reception signal can be regarded as the interference generated by the transmitter 2 to the receiver 3. In addition, since the reference reception signal can be regarded as the interference generated by the transmitter 2 to the receiver 3, the controller 4 uses the reference reception signal as the interference compensation signal and stores the interference compensation signal. In some embodiments, the controller 4 further includes a storage unit 43, and the controller 4 stores the interference compensation signal in the storage unit 43 of the controller 4.

Then, when there is a target object 5, how the transmitter 2 and the receiver 3 of the present disclosure transmit and receive signals is described as the following. Moreover, how the distance sensing system 1 of the present disclosure uses the above-mentioned interference compensation signal to calculate the distance d between the distance sensing system 1 and the target object 5 is described.

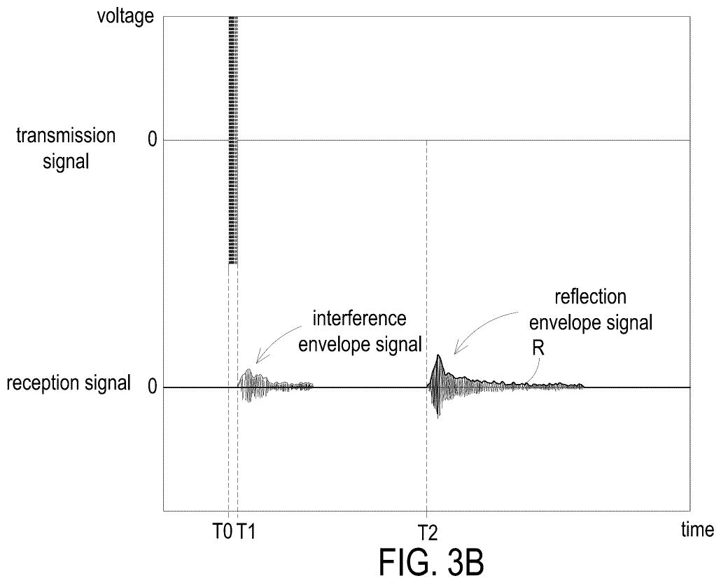

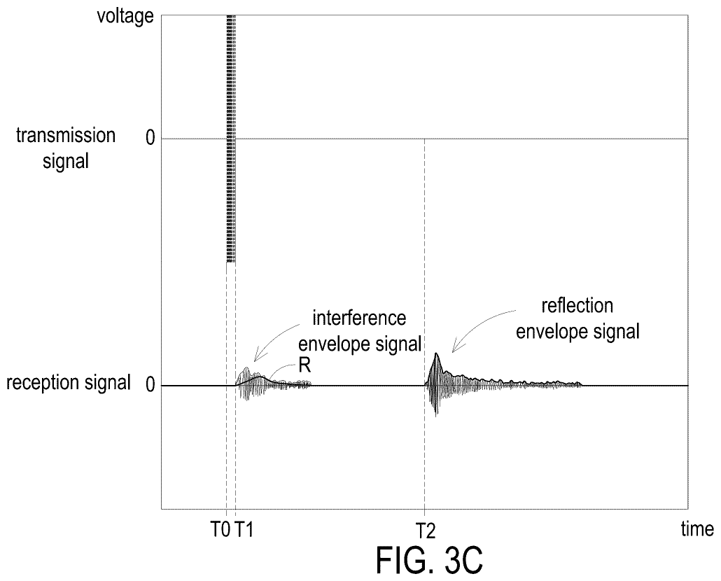

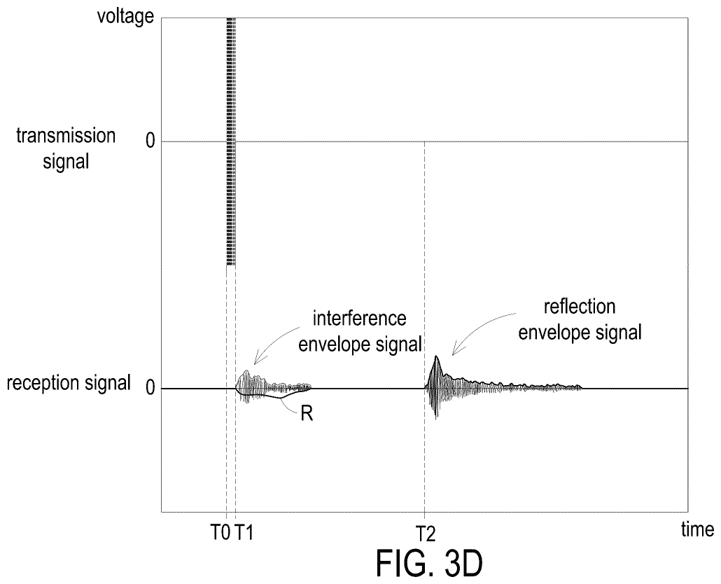

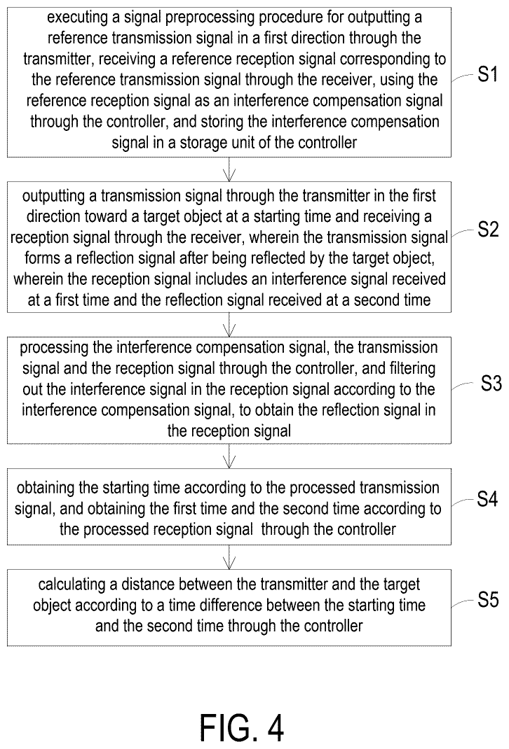

Please refer to FIG. 1A, FIG. 1B and FIG. 3A again. FIG. 3A is a signal diagram illustrating a transmission signal and a reception signal of the transmitter 2 and the receiver 3 in FIG. 1B.

In an embodiment, when the distance sensing system 1 performs a distance sensing operation on the target object 5, the controller 4 drives the transmitter 2 to operate, so that the transmitter 2 outputs the transmission signal in the first direction F1. The controller 4 also drives the receiver 3 to operate, so that the receiver 3 receives the aforementioned reception signal. Preferably but not exclusively, the reception signal includes an interference signal received at a first time T1 and a reflection signal received at a second time T2. The first time T1 is between the starting time TO and the second time T2. In the present disclosure, the distance between the transmitter 2 and the receiver 3 in the distance sensing system 1 is much smaller than the distance d between the distance sensing system 1 and the target object 5. Therefore, the receiver 3 first receives the interference signal generated by the transmitter 2 to the receiver 3, and then receives the reflection signal after being reflected by the target object 5.

Notably, in FIG. 1C, the receiver 3 is provided without a target object, and the reference reception signal received by the receiver 3 can be regarded as the interference generated by the transmitter 2 to the receiver 3. In FIG. 1B, the receiver 3 is provided with the target object 5, and the interference signal received by the receiver 3 can also be regarded as the interference generated by the transmitter 2 to the receiver 3. Therefore, both the reference reception signal and the interference signal can be regarded as the interference generated by the transmitter 2 to the receiver 3. Since both the reference reception signal and the interference signal can be regarded as the interference generated by the transmitter 2 to the receiver 3, the controller 4 can filter out the interference signal in the reception signal according to the interference compensation signal to obtain the reflection signal in the reception signal.

When the distance sensing system 1 of the present disclosure performs distance sensing between the distance sensing system 1 and the target object 5, the interference signal in the reception signal received by the receiver 3 can be filtered out to obtain a reception signal without interference. Then, the distance d between the distance sensing system 1 and the target object 5 can be calculated. Since the distance d is obtained by calculating based on the reception signal without interference, the accuracy of distance sensing can be improved and the blind zone limitation of the system's close-range distance sensing can be overcome.

In the embodiment, the distance d between the distance sensing system 1 and the target object 5 is much larger than the distance between the transmitter 2 and the receiver 3 of the distance sensing system 1. Therefore, the distance between the transmitter 2 and the target object 5 and the distance between the receiver 3 and the target object 5 can both be regarded as the distance d between the distance sensing system 1 and the target object 5.

In some embodiments, the distance d between the distance sensing system 1 and the target object 5 is greater than a preset distance between the transmitter 2 and the receiver 3. If the distance d between the distance sensing system 1 and the target object 5 is smaller than the preset distance between the transmitter 2 and the receiver 3, the distance sensing between the distance sensing system 1 and the target object 5 cannot be performed.

Please refer to FIG. 1A, FIG. 2 and FIG. 3A simultaneously. In some embodiments, the controller 4 of the present disclosure further includes an envelope detector 40 and a filter 41 electrically connected to each other. In the embodiment, the envelope detector 40 extracts the interference compensation signal as a compensation envelope signal, and extracts the reception signal as a reception envelope signal. Moreover, the reception envelope signal includes an interference envelope signal and a reflection envelope signal corresponding to the interference signal and the reflection signal, respectively. In the embodiment, the controller 4 compares the compensation envelope signal with the interference envelope signal. When the compensation envelope signal matches the interference envelope signal, the filter 41 filters out the interference signal in the reception signal according to the compensation envelope signal.

In some embodiments, the controller 4 of the present disclosure further includes a signal processor 42 electrically connected to the envelope detector 40 and the filter 41. Before the envelope detector 40 extracts the interference compensation signal and the reception signal as the compensation envelope signal and the reception envelope signal, respectively, the signal processor 42 performs signal conversion on the interference compensation signal and the reception signal, and the envelope detector 40 extracts the interference compensation signal converted and the reception signal converted as the compensation envelope signal and the reception envelope signal. The reception envelope signal includes the interference envelope signal and the reflection envelope signal. Preferably but not exclusively, the signal conversion is Fourier transform or Hilbert transform. In some embodiments, the controller 4 defines a timing of obtaining the interference envelope signal as the first time T1, and defines a timing of obtaining the reflection envelope signal as the second time T2.

In some embodiments, the envelope detector 40 further extracts the transmission signal as a transmission envelope signal. In addition, before the envelope detector 40 extracts the transmission signal as the transmission envelope signal, the signal processor 42 performs signal conversion on the transmission signal, and the envelope detector 40 extracts the transmission signal converted as a transmission envelope signal. Preferably but not exclusively, the signal conversion is Fourier transform or Hilbert transform. In some embodiments, the controller 4 defines a timing of obtaining the transmission envelope signal as the starting time T0.

In some embodiments, in case of that the compensation envelope signal and the interference envelope signal are not matched, the controller 4 cannot filter out the interference signal in the reception signal according to the compensation envelope signal, so that the reflection signal cannot be obtained in the reception signal. At this time, the controller 4 updates the interference compensation signal stored in the controller 4. Preferably but not exclusively, the controller 4 updates the interference compensation signal by using the transmitter 2 and the receiver 3 to transmit and receive the signal again without the target object to obtain an updated interference compensation signal. The controller 4 obtains the interference compensation signal in the manner described above, so it will not be redundantly described herein.

In case of that the compensation envelope signal and the interference envelope signal are matched, the controller 4 of the present embodiment can also use the relationship between a peak value of the reflection envelope signal and a threshold value to determine whether the distance d between the distance sensing system 1 and the target object 5 can be calculated. When the peak value of the reflection envelope signal is greater than or equal to the threshold value, it means that the reflection envelope signal can be detected. Therefore, the controller 4 determines that the distance d between the distance sensing system 1 and the target object 5 can be calculated. The controller 4 filters out the interference envelope signal in the reception envelope signal according to the compensation envelope signal to obtain the reflection signal in the reception signal, and the controller 4 can calculate the distance d between the distance sensing system 1 and the target object 5 based on this. On the contrary, when the peak value of the reflection envelope signal is less than the threshold value, it means that the reflection envelope signal cannot be detected. Therefore, the controller 4 determines that the distance d between the distance sensing system 1 and the target object 5 cannot be calculated. In some embodiments, in case of that the distance d between the distance sensing system 1 and the target object 5 cannot be calculated, it indicates that the distance between the target object 5 and the distance sensing system 1 is too large, for example, larger than the distance sensing range.

Please refer to FIG. 3B, FIG. 3C and FIG. 3D again. FIG. 3B is a schematic diagram illustrating that the compensation envelope signal and the interference envelope signal are matched. FIG. 3C is a schematic diagram illustrating that the compensation envelope signal and the interference envelope signal are not matched, and a convex state is caused. FIG. 3D is a schematic diagram illustrating that the compensation envelope signal and the interference envelope signal are not matched and a concave state is caused. In some embodiments, the controller 4 can compare the compensated envelope signal and the interference envelope signal by reversely checking whether the reflection envelope signal after filtering out the interference envelope signal from the reception envelope signal has deviation or over-compensation. If the compensation envelope signal and the interference envelope signal are matched, the signal time except the reflection envelope signal should be flat at the signal zero level, as shown in FIG. 3B (such as the signal indicated by symbol R in FIG. 3B). On the contrary, if the compensation envelope signal and the interference envelope signal are not matched, the signal time except the reflection envelope signal includes an under-compensated signal with a convex state (such as the signal indicated by symbol R in FIG. 3C) and an over-compensated signal with a concave state (such as indicated by symbol R in FIG. 3D).

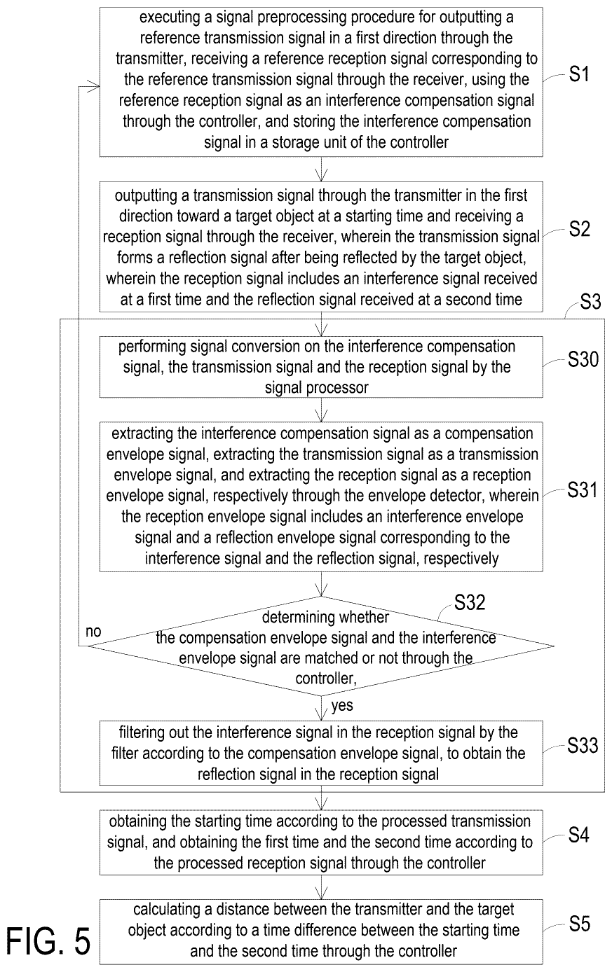

FIG. 4 is a flow chart illustrating a distance sensing method according to a first embodiment of the present disclosure. The distance sensing method of this embodiment is applicable to the aforementioned distance sensing system 1. Please refer to FIG. 1A, FIG. 1B, FIG. 1C and FIG. 4 simultaneously. The method of the present disclosure includes the following steps. First, in a step S1, the distance sensing system 1 executes a signal preprocessing procedure. In the aforementioned signal preprocessing procedure, the controller 4 drives the transmitter 2 to operate, so that the transmitter 2 outputs a reference transmission signal in the first direction F1, and the controller 4 drives the receiver 3 to operate, so that the receiver 3 receives a reference reception signal corresponding to the aforementioned reference transmission signal. In addition, the controller 4 uses the reference reception signal as an interference compensation signal and stores the interference compensation signal in the storage unit 43 of the controller 4. Then, in a step S2, the distance sensing system 1 performs a distance sensing procedure on the target object 5. In the aforementioned distance sensing procedure, the controller 4 drives the transmitter 2 to operate, so that the transmitter 2 outputs a transmission signal in the first direction F1 toward the target object 5 at a starting time T0. The transmission signal is reflected by the target object 5 to form a reflection signal. In addition, the controller 4 also drives the receiver 3 to operate, so that the receiver 3 receives a reception signal. In the embodiment, the reception signal includes the interference signal received at the first time T1 and the reflection signal received at the second time T2. Thereafter, in a step S3, the interference compensation signal, the transmission signal and the reception signal are processed by the controller 4, and the controller 4 filters out the interference signal in the reception signal according to the interference compensation signal to obtain the reflection signal in the reception signal. Then, in a step S4, the controller 4 obtains the starting time T0 according to the processed transmission signal, and obtains the first time T1 and the second time T2 according to the processed reception signal. Finally, in a step S5, the controller 4 calculates the distance d between the distance sensing system 1 and the target object 5 according to the time difference between the starting time T0 and the second time T2.

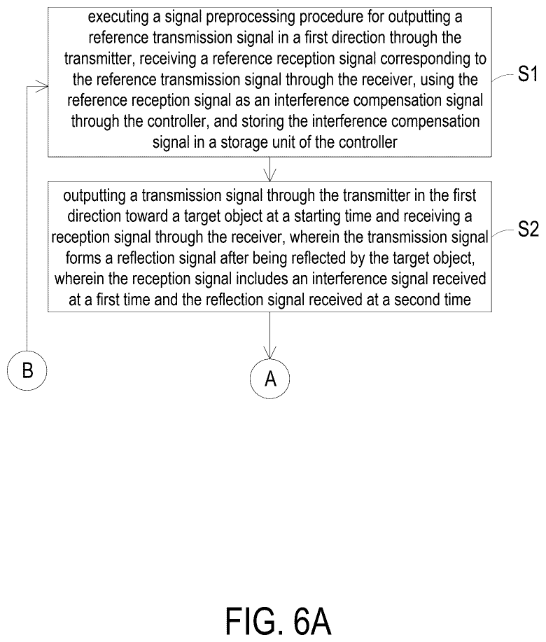

FIG. 5 is a flow chart illustrating a distance sensing method according to a second embodiment of the present disclosure. The distance sensing method of this embodiment is applicable to the aforementioned distance sensing system 1 and the aforementioned distance sensing method. Please refer to FIG. 1A, FIG. 2, FIG. 3 and FIG. 5 simultaneously. The process steps of the distance sensing method of this embodiment are similar to the process steps of the embodiment shown in FIG. 4 and not redundantly described herein. Different from the step S3 shown in FIG. 4, the method of this embodiment further includes the following steps in the step S3. In a step S31, the interference compensation signal, the transmission signal and the reception signal are respectively extracted as a compensation envelope signal, a transmission envelope signal and a reception envelope signal by the envelope detector 40 of the controller 4. Preferably but not exclusively, the reception envelope signal includes an interference envelope signal and a reflection envelope signal corresponding to the interference signal and the reflection signal, respectively. In a step S32, the controller 4 compares and determines whether the compensation envelope signal and the interference envelope signal are matched. When the controller 4 determines that the compensation envelope signal and the interference envelope signal are matched, a step S33 is executed to enable the filter 41 of the controller 4 to filter out the interference signal in the reception signal according to the compensation envelope signal to obtain the reflection signal in the reception signal. When the controller 4 determines that the compensation envelope signal and the interference envelope signal are not matched, the step S1 is re-executed.

In some embodiments, the distance sensing method of the present disclosure further includes a pre-processing step S30 before the step S31. In the step S30, the signal processor 42 of the controller 4 performs signal conversion on the interference compensation signal, the transmission signal, and the reception signal. Preferably but not exclusively, the signal transformation is Fourier transform or Hilbert transform.

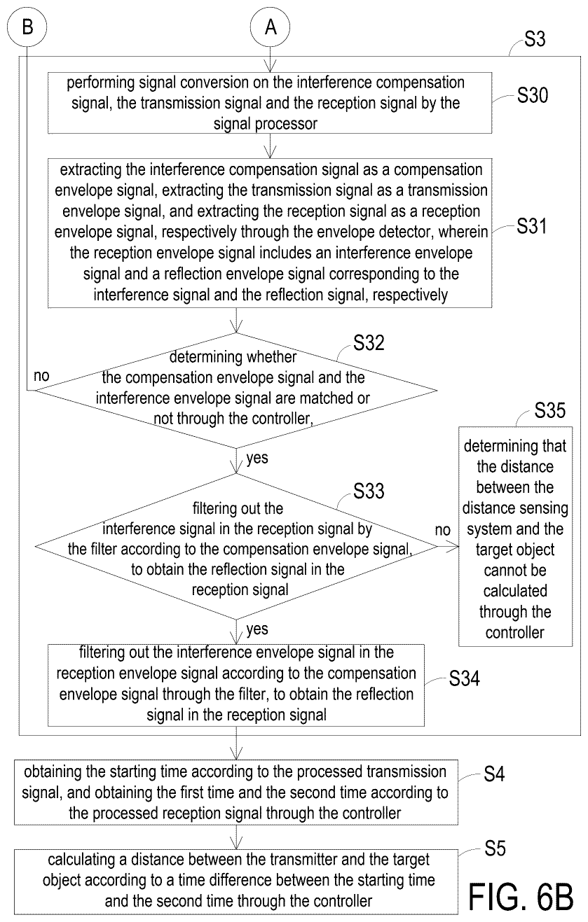

FIG. 6A and FIG. 6B are a flow chart illustrating a distance sensing method according to a third embodiment of the present disclosure. The distance sensing method of this embodiment is applicable to the aforementioned distance sensing system 1 and the aforementioned distance sensing method. Please refer to FIG. 1A, FIG. 2, FIG. 3, FIG. 6A and FIG. 6B simultaneously. The process steps of the distance sensing method of this embodiment are similar to the process steps of the embodiment shown in FIG. 5 and not redundantly described herein. Different from the step S3 shown in FIG. 5, the method of this embodiment further includes the following steps in the step S3.

In a step S31, the interference compensation signal, the transmission signal and the reception signal are respectively extracted as a compensation envelope signal, a transmission envelope signal and a reception envelope signal by the envelope detector 40 of the controller 4. Preferably but not exclusively, the reception envelope signal includes an interference envelope signal and a reflection envelope signal corresponding to the interference signal and the reflection signal, respectively. In a step S32, the controller 4 compares and determines whether the compensation envelope signal and the interference envelope signal are matched or not. When the controller 4 determines that the compensation envelope signal and the interference envelope signal are matched, a step S33 is executed. When the controller 4 determines that the compensation envelope signal and the interference envelope signal are matched, the step S1 is re-executed again. In a step S33, the controller 4 determines whether a peak value of the reflection envelope signal is greater than or equal to a preset threshold value. When the controller 4 determines that the peak value of the reflection envelope signal is greater than or equal to the preset threshold value, a step S34 is executed to enable the filter 41 of the controller 4 to filter out the interference envelope signal in the reception envelope signal according to the compensation envelope signal to obtain the reflection signal in the reception signal. After obtaining the reflection signal in the reception signal, the step S4 is executed. When the controller 4 determines that the peak value of the reflected envelope signal is smaller than the threshold value, a step S35 is executed. In the step S35, the controller 4 determines that the distance d between the distance sensing system 1 and the target object 5 cannot be calculated.

In some embodiments, the distance sensing method of the present disclosure further includes a pre-processing step S30 before the step S31. In the step S30, the signal processor 42 of the controller 4 performs signal conversion on the interference compensation signal, the transmission signal, and the reception signal. Preferably but not exclusively, the signal transformation is Fourier transform or Hilbert transform.

In some embodiments, the distance sensing system 1 further includes a temperature sensor 6 electrically connected to the controller 4 for sensing an ambient temperature of the distance sensing system 1. In this embodiment, the distance sensing method further include a following step after step S1. When the temperature sensor 6 senses a change in the ambient temperature, the step S1 is re-executed to update and obtain the aforementioned interference compensation signal.

In summary, the present disclosure provides a distance sensing system and a distance sensing method, capable of filtering out the interference signal in the signal received by the receiver when sensing the distance between the distance sensing system and the target object, thereby obtaining a reception signal without interference. Then the distance between the distance sensing system and the target object can be calculated. Since the distance is obtained by calculating based on the reception signal without interference, the distance sensing accuracy is improved and the blind zone limitation of the close-range sensing is overcome.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A distance sensing system, comprising:
a transmitter, outputting a reference transmission signal in a first direction;
a receiver, receiving a reference reception signal corresponding to the reference transmission signal; and
a controller, connected to the transmitter and the receiver and comprising a storage unit, wherein the controller uses the reference reception signal as an interference compensation signal and stores the interference compensation signal in the storage unit;
wherein the transmitter is further used to output a transmission signal toward a target object in the first direction at a starting time, and the transmission signal forms a reflection signal after being reflected by the target object, wherein the receiver is further used to receive a reception signal, and the reception signal comprises an interference signal received at a first time and the reflection signal received at a second time;
wherein the controller is further used to filter out the interference signal in the reception signal according to the interference compensation signal, to obtain the reflection signal in the reception signal,
wherein the controller is further used to calculate a distance between the transmitter and the target object according to a time difference between the starting time and the second time.

2. The distance sensing system according to claim 1, wherein the distance is calculated according to the following formula:
$$d = \frac{( T 2 - T 0 ) * V}{2}$$
wherein d is the distance, T2 is the second time, T0 is the starting time, and V is a transmission speed of the transmission signal.

3. The distance sensing system according to claim 1, wherein the receiver and the transmitter are arranged in a second direction, the second direction is perpendicular to the first direction, and the distance is greater than a preset distance between the transmitter and the receiver.

4. The distance sensing system according to claim 1, wherein the controller is further used for processing the interference compensation signal, the transmission signal and the reception signal, and obtaining the starting time according to the processed transmission signal, and obtaining the first time and the second time according to the processed reception signal.

5. The distance sensing system according to claim 4, wherein the controller further comprises an envelope detector and a filter, wherein the envelope detector extracts the interference compensation signal as a compensation envelope signal, extracts the transmission signal as a transmission envelope signal, and extracts the reception signal as a reception envelope signal, wherein the reception envelope signal includes an interference envelope signal and a reflection envelope signal corresponding to the interference signal and the reflection signal, respectively, wherein the controller defines a timing of obtaining the transmission envelope signal as the starting time, defines a timing of obtaining the interference envelope signal as the first time, and defines a timing of obtaining the reflection envelope signal as the second time, wherein the controller compares the compensation envelope signal and the interference envelope signal, and the filter filters out the interference signal in the reception signal according to the compensation envelope signal when the compensation envelope signal matches the interference envelope signal.

6. The distance sensing system according to claim 5, wherein the controller further comprises a signal processor electrically connected to the envelope detector and the filter, wherein before the envelope detector extracts the interference compensation signal, the transmission signal and the reception signal as the compensation envelope signal, the transmission envelope signal and the reception envelope signal, respectively, the signal processor performs signal conversion on the interference compensation signal, the transmission signal and the reception signal, wherein the envelope detector extracts the interference compensation signal converted, the transmission signal converted and the reception signal converted as the compensation envelope signal, the transmission envelope signal and the reception envelope signal, and the reception envelope signal includes the interference envelope signal and the reflection envelope signal.

7. The distance sensing system according to claim 1, wherein the distance sensing system further comprises a temperature sensor electrically connected to the controller for sensing an ambient temperature of the distance sensing system, wherein when the temperature sensor senses a change in the ambient temperature, the controller controls the transmitter and the receiver to operate, so as to update the interference compensation signal.

8. A distance sensing method of a distance sensing system, wherein the distance sensing system comprises a transmitter, a receiver and a controller, and the distance sensing method comprises steps of:
(S1) executing a signal preprocessing procedure for outputting a reference transmission signal in a first direction through the transmitter, receiving a reference reception signal corresponding to the reference transmission signal through the receiver, using the reference reception signal as an interference compensation signal through the controller, and storing the interference compensation signal in a storage unit of the controller;
(S2) outputting a transmission signal through the transmitter in the first direction toward a target object at a starting time and receiving a reception signal through the receiver, wherein the transmission signal forms a reflection signal after being reflected by the target object, wherein the reception signal includes an interference signal received at a first time and the reflection signal received at a second time;
(S3) processing the interference compensation signal, the transmission signal and the reception signal through the controller, and filtering out the interference signal in the reception signal according to the interference compensation signal, to obtain the reflection signal in the reception signal;
(S4) obtaining the starting time according to the processed transmission signal, and obtaining the first time and the second time according to the processed reception signal through the controller; and
(S5) calculating a distance between the transmitter and the target object according to a time difference between the starting time and the second time through the controller.

9. The distance sensing method according to claim 8, wherein the distance is calculated according to the following formula:
$$d = \frac{( T 2 - T 0 ) * V}{2}$$
wherein d is the distance, T2 is the second time, T0 is the starting time, and V is a transmission speed of the transmission signal.

10. The distance sensing method according to claim 8, wherein the receiver and the transmitter are arranged in a second direction, the second direction is perpendicular to the first direction, and the distance is greater than a preset distance between the transmitter and the receiver.

11. The distance sensing method according to claim 8, wherein the controller further comprises an envelope detector and a filter, wherein the step (S3) of the distance sensing method further comprises steps of:
(S31) extracting the interference compensation signal as a compensation envelope signal, extracting the transmission signal as a transmission envelope signal, and extracting the reception signal as a reception envelope signal, respectively through the envelope detector, wherein the reception envelope signal includes an interference envelope signal and a reflection envelope signal corresponding to the interference signal and the reflection signal, respectively;
(S32) determining whether the compensation envelope signal and the interference envelope signal are matched or not through the controller, wherein in case of that the compensation envelope signal and the interference envelope signal are matched in the step (S32), a step (S33) is executed, wherein in case of that the compensation envelope signal and the interference envelope signal are not matched in the step (S32), the step (S31) is executed again; and
(S33) filtering out the interference envelope signal in the reception envelope signal according to the compensation envelope signal through the filter, to obtain the reflection signal in the reception signal.

12. The distance sensing method according to claim 11, wherein the controller further comprises a signal processor electrically connected to the envelope detector and the filter, and the step (S31) further comprises a pre-processing step of:
(S30) performing signal conversion on the interference compensation signal, the transmission signal and the reception signal by the signal processor, wherein the envelope detector extracts the interference compensation signal converted, the transmission signal converted and the reception signal converted as the compensation envelope signal, the transmission envelope signal and the reception envelope signal, and the reception envelope signal includes the interference envelope signal and the reflection envelope signal.

13. The distance sensing method according to claim 8, wherein the controller further comprises an envelope detector and a filter, wherein the step (S3) of the distance sensing method further comprises steps of:
(S31) extracting the interference compensation signal as a compensation envelope signal, extracting the transmission signal as a transmission envelope signal, and extracting the reception signal as a reception envelope signal, respectively through the envelope detector, wherein the reception envelope signal includes an interference envelope signal and a reflection envelope signal corresponding to the interference signal and the reflection signal, respectively;
(S32) determining whether the compensation envelope signal and the interference envelope signal are matched or not through the controller, wherein in case of that the compensation envelope signal and the interference envelope signal are matched in the step (S32), a step (S33) is executed, wherein in case of that the compensation envelope signal and the interference envelope signal are not matched in the step (S32), the step (S1) is re-executed again; and
(S33) determining whether a peak value of the reflection envelope signal is greater than a threshold value or not, through the controller, wherein in case of that the determination result of the step (S33) is yes, a step (S34) is executed, wherein in case of that the determination result of step (S34) is no, a step (S35) is executed;
(S34) filtering out the interference envelope signal in the reception envelope signal according to the compensation envelope signal through the filter, to obtain the reflection signal in the reception signal; and
(S35) determining that the distance between the distance sensing system and the target object cannot be calculated through the controller.

14. The distance sensing method according to claim 8, wherein the distance sensing system further comprises a temperature sensor electrically connected to the controller for sensing an ambient temperature of the distance sensing system, wherein the step (S1) is re-executed to update the interference compensation signal when the temperature sensor senses a change in the ambient temperature.
